(19) United States
(12) Patent Application Publication
(10) Pub. No.: US 2017/0122510 A1
(43) Pub. Date: May 4, 2017

(54) LIGHTING DEVICE, FIXTURE BODY FOR LIGHTING DEVICE, AND LIGHT-EMITTING UNIT

(71) Applicant: Iris Ohyama Inc., Sendai-shi (JP)

(72) Inventors: Naoki Tanifuji, Kakuda-shi (JP); Rutsuko Akiyama, Kakuda-shi (JP); Madoka Azumi, Kakuda-shi (JP)

(21) Appl. No.: 15/317,478

(22) PCT Filed: Jun. 9, 2015
(86) PCT No.: PCT/JP2015/002890

§ 371 Date: Dec. 9, 2016

(30) Foreign Application Priority Data
Jun. 13, 2014 (JP) 2014-122889
Jun. 13, 2014 (JP) 2014-122890
Jun. 13, 2014 (JP) 2014-122891

(51) Int. Cl. F21S 8/04; F21V 23/00; F21V 17/06; F21V 3/02; F21V 7/04; F21V 19/00; F21S 8/00; F21V 23/02

(52) U.S. Cl. CPC F21S 8/04; F21S 8/033; F21V 23/001; F21V 23/02; F21V 3/02; F21V 7/04; F21V 19/0015; F21V 17/06; F21Y 2103/10

(57) ABSTRACT

A lighting device, a fixture body for a lighting device (hereinafter, referred to as a “fixture body”), and a light-emitting unit mounted to the lighting device have excellent appearance. The lighting device is constituted of the light-emitting unit and the fixture body to which the light-emitting unit is mounted, and the light-emitting unit includes the light-emitting element and a light-transmissive cover that covers the light-emitting element and has an elongated shape. A cross-section of the light-transmissive cover orthogonal to a longitudinal direction of the light-emitting unit is U-shaped, and the fixture body includes a light-emitting unit mounting recess into which at least an opening-side end constituting the U-shape of the light-transmissive cover is inserted.

### TECHNICAL FIELD

This disclosure relates to a lighting device, a fixture body for a lighting device, and a light-emitting unit.

### BACKGROUND

Hitherto, lighting devices have been widely used in which an illuminant such as a fluorescent lamp is mounted to a fixture body, and the fixture body is mounted to a mounting surface of a ceiling, a wall or the like. In addition, in recent years, light-emitting diodes (LED) which are lower in power consumption and more excellent in durability than incandescent light bulbs or fluorescent lamps having been used hitherto have often been used as light-emitting elements.

Therefore, a large number of lighting devices for ceiling or wall mounting in which an LED is used as a light-emitting element have been proposed. For example, JP-A-2013-179014 discloses a lighting device having a light-emitting unit including a light-emitting element mounted to a fixture body which is mounted to a ceiling or the like, and supplies power to the light-emitting unit, to thereby allow the light-emitting unit to emit light. In addition, for example, Japanese Patent No. 4045788 discloses a lighting device that has a sheet metal-made reflecting shade mounted to a sheet metal-made fixture body using a fastening plate.

However, in the above-described lighting device, there is a problem in that the central portion of an elongated light-emitting unit warps. This is because, the fixture body is provided with a mounting member for mounting the light-emitting unit, but there is a limitation to a position at which the mounting member is provided, and the central portion of the fixture body may not be able to be provided with the mounting member.

The fixture body requires hole portions for a mounting screw for connection to the mounting surface of a ceiling, a wall surface or the like, and a space to receive a cable for power supply connected to the light-emitting unit and a power supply portion, and has a limitation to the mounting position of the mounting member. For this reason, it is difficult to suppress warpage of the light-emitting unit by adjusting the mounting position of the mounting member.

When the central portion of the light-emitting unit warps, appearance defects of the lighting device may occur due to the occurrence of a gap in a boundary portion between the fixture body and the light-emitting unit.

It could therefore be helpful to provide a lighting device, a fixture body for a lighting device, and a light-emitting unit having satisfactory appearance even when the light-emitting unit warps.

### SUMMARY

We thus provide a lighting device including: an elongated light-emitting unit including a light-emitting element and a light-transmissive cover that covers the light-emitting element; and a fixture body to which the light-emitting unit is mounted, wherein a cross-section of the light-transmissive cover orthogonal to a longitudinal direction of the light-emitting unit is U-shaped, and the fixture body includes a light-emitting unit mounting recess into which at least an opening-side end constituting the U-shape of the light-transmissive cover is inserted.

We also provide a fixture body for a lighting device, wherein a light-emitting unit is mounted in which a light-emitting element is covered with a light-transmissive cover which has an elongated shape and of which a cross-section orthogonal to a longitudinal direction is U-shaped, and the fixture body includes a light-emitting unit mounting recess into which at least an opening-side end constituting the U-shape in the light-transmissive cover is inserted.

We further provide a light-emitting unit including: a light-emitting element; and a light-transmissive cover that covers the light-emitting element, wherein the light-transmissive cover is configured such that a cross-section of the light-transmissive cover orthogonal to a longitudinal direction of the light-transmissive cover is U-shaped, and that when the light-emitting unit is mounted to a fixture body for a lighting device including a light-emitting unit mounting recess for light-emitting unit mounting, at least an opening-side end constituting the U-shape is inserted into the light-emitting unit mounting recess and has an elongated shape.

It is thus possible to obtain a lighting device, a fixture body for a lighting device, and a light-emitting unit which have satisfactory appearance even when the light-emitting unit warps.

### BRIEF DESCRIPTION OF THE DRAWINGS

FIG. 1 is a perspective view illustrating the appearance of a lighting device according to an example.

FIGS. 2 (A) to 2(E) are orthographic views illustrating the appearance of the lighting device according to the example.

FIG. 3 is a perspective view illustrating the appearance of the lighting device according to the example from a light-emitting unit side.

FIGS. 4(A) and 4(B) are exploded perspective views illustrating the configuration of the lighting device according to the example.

FIG. 5 is a perspective cross-sectional view illustrating the configuration of the lighting device according to the example.

FIGS. 6 (A) and 6(B) are perspective views illustrating the appearance of a fixture body of the lighting device according to the example.

FIGS. 7(A) and 7(B) are diagrams illustrating a position regulation member that regulates the position of the light-emitting unit which is provided in the lighting device according to the example.

FIG. 8 is a perspective view illustrating the appearance of the light-emitting unit according to the lighting device according to the example.

FIG. 9 is a cross-sectional view of the lighting device according to the example.

FIG. 10 is a plan view illustrating a light-emitting element substrate included in the light-emitting unit according to the example.

FIG. 11 is a perspective cross-sectional view illustrating the configuration of a light-emitting element support member of the light-emitting unit according to the example.

FIG. 12 is a perspective cross-sectional view illustrating the configuration of the light-emitting element support member of the light-emitting unit according to the example.

FIG. 13 is an exploded perspective view illustrating the configuration of a power supply portion of the light-emitting unit according to the example.

FIG. 14 is a perspective cross-sectional view illustrating the configuration of a reflecting member of the light-emitting unit according to the example.

### REFERENCE SIGNS LIST

1: Lighting device
10: Fixture body
13: Spring portion
111: Light-emitting unit mounting recess
20: Light-emitting unit
21: Light-emitting element
22: Light-transmissive cover
221: Light transmission portion
222: Inserting portion
27: Spring receiving portion
28: Power supply portion
40: Power supply cable

### DETAILED DESCRIPTION

Hereinafter, an example of a lighting device will be described. In the following example, a description may be given in which, when the lighting device is mounted to a ceiling, a direction facing the ceiling is an “upward” direction of the lighting device, and a floor direction is a “downward” direction of the lighting device. In the drawings, when the lighting device is mounted to the ceiling, a vertically upward direction (ceiling direction) may be a “Z” direction, and the floor direction may be a “−Z” direction. In this case, one direction of the elongated lighting device in a longitudinal direction may be an “X” direction, the other direction may be a “−X” direction, one direction of the elongated lighting device in a width direction may be a “Y” direction, and the other direction may be a “−Y” direction.

### Entire Configuration of Lighting Device

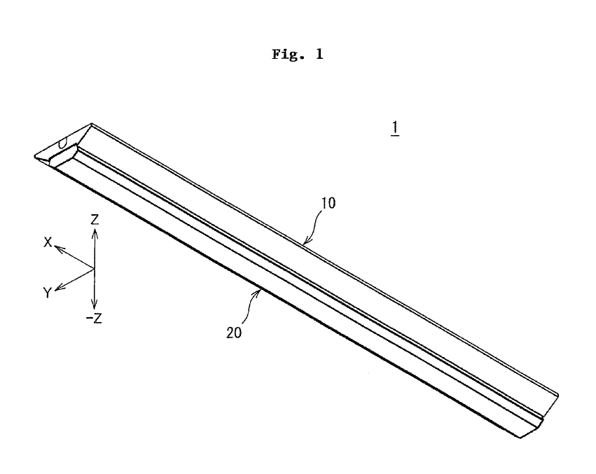

FIG. 1 is a perspective view illustrating the appearance of a lighting device 1 according to an example.

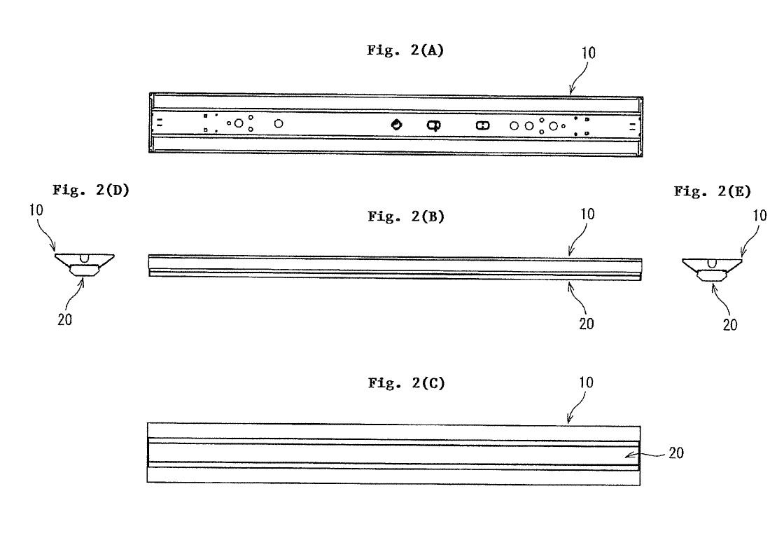

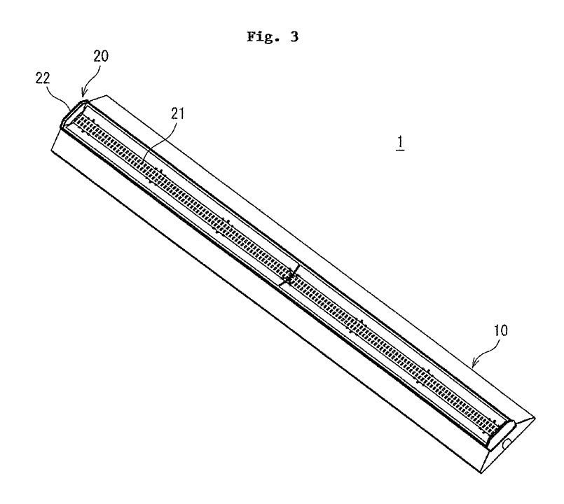

FIGS. 2(A) to 2(E) are orthographic views illustrating the appearance of the lighting device 1; FIG. 2(A) is a top view of the lighting device 1, FIG. 2(B) is a side view of the lighting device 1, FIG. 2(C) is a bottom view of the lighting device 1, FIG. 2(D) is a front view of the lighting device 1, and FIG. 2(E) is a rear view of the lighting device 1. In addition, since FIG. 2(B) is a right side view of the lighting device 1, and a left side view of the lighting device 1 is substantially the same as the right side view, the left side view will be not shown.

FIG. 3 is a perspective view illustrating the appearance of the lighting device 1 from a light-emitting unit 20 side.

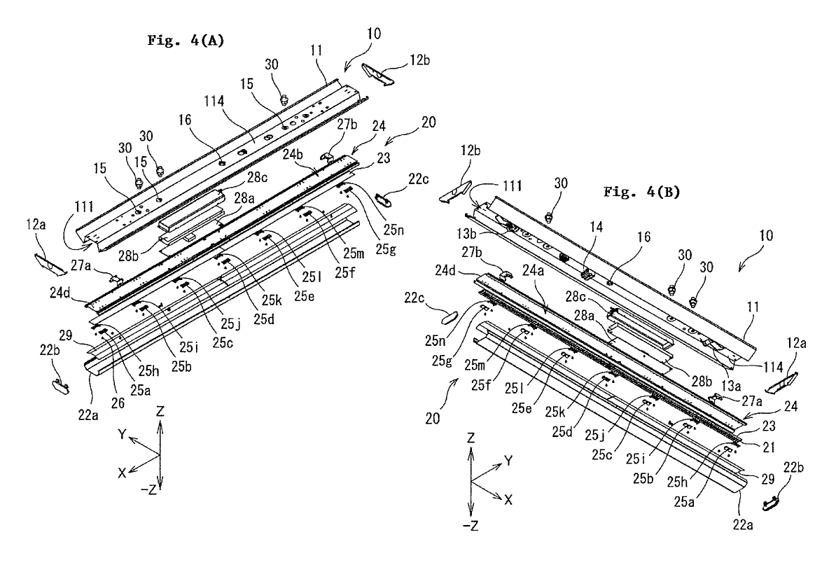

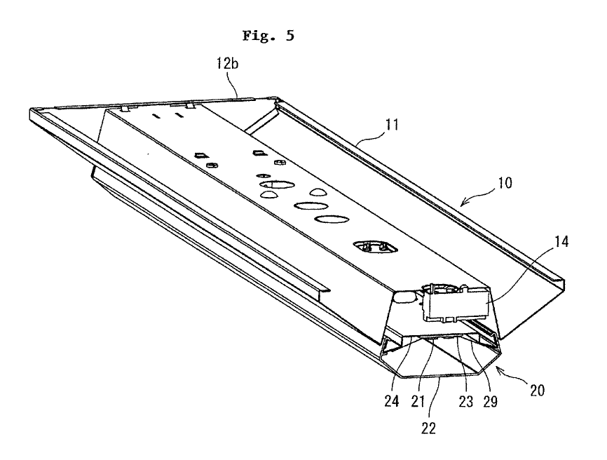

FIGS. 4(A) and 4(B) are exploded perspective views illustrating the configuration of the lighting device 1; FIG. 4(A) is an exploded perspective view of the lighting device 1 from above, and FIG. 4(B) is an exploded perspective view of the lighting device 1 from below.

FIG. 5 is a perspective cross-sectional view illustrating the configuration of the lighting device 1.

The lighting device 1 includes a fixture body for a lighting device (hereinafter, referred to as a “fixture body”) 10 and the light-emitting unit 20. The fixture body 10 is mounted to the mounting surface of, for example, a ceiling, a wall or the like. The light-emitting unit 20 is mounted to the fixture body 10.

The light-emitting unit 20 includes a light-emitting element 21, for example, an LED, and a light-transmissive cover 22 that covers the light-emitting element 21.

The fixture body 10 includes a light-emitting unit mounting recess 111 provided with an opening having the light-emitting unit 20 mounted therein so that the light-transmissive cover 22 of the light-emitting unit 20 is inserted. That is, the light-emitting unit 20 is mounted to the fixture body 10 in a state where a portion of the light-transmissive cover 22 is inserted into the light-emitting unit mounting recess 111. A portion of the light-transmissive cover 22 inserted into the light-emitting unit mounting recess 111 is a portion located on the mounting surface side of the light-transmissive cover 22.

The light-emitting unit mounting recess 111 of the fixture body 10 widens from the bottom of the light-emitting unit mounting recess 111 toward the end edge of the opening. In other words, a pair of inner walls constituting the light-emitting unit mounting recess 111 are inclined to widen outside so that an interval of the pair of inner walls widens from the bottom with increasing distance from a direction perpendicular to the bottom. The light-emitting unit 20 is in contact with the inner walls constituting the light-emitting unit mounting recess 111. The bottom of the light-emitting unit mounting recess 111 is located on the upper side (side facing a ceiling) of the fixture body 10 in a state where the fixture body 10 is mounted to the ceiling.

### Fixture Body

Hereinafter, the configuration of the fixture body 10 will be described.

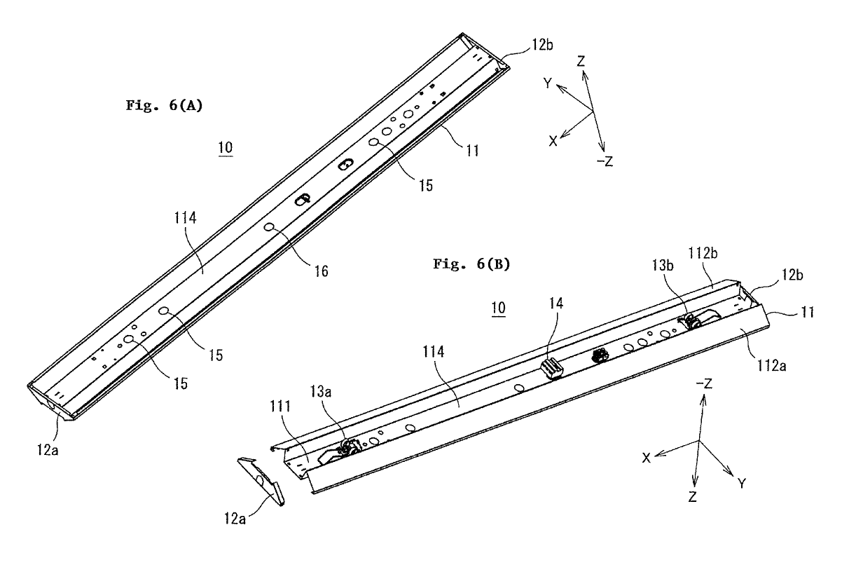

FIGS. 6(A) and 6(B) are perspective views illustrating the appearance of the fixture body 10; FIG. 6(A) is a perspective view illustrating the appearance of the fixture body 10 from above, and FIG. 6(B) is a perspective view illustrating the appearance of the fixture body 10 from below.

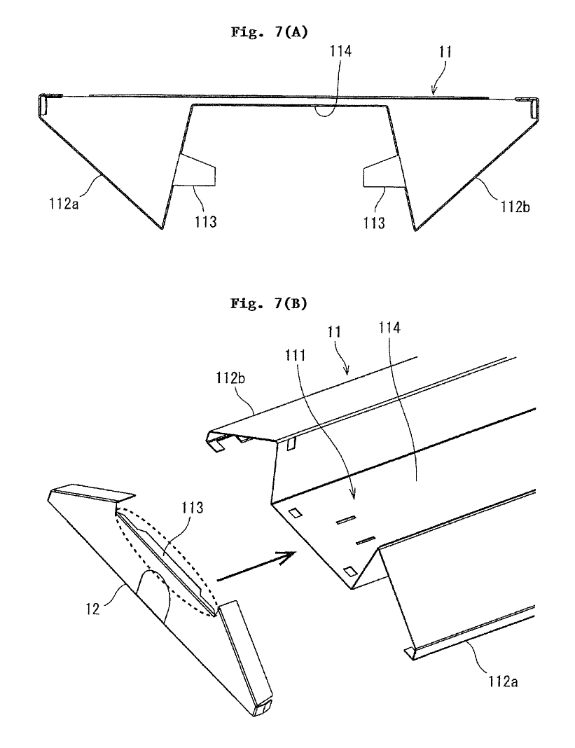

FIGS. 7(A) and 7(B) are diagrams illustrating a position regulation member that regulates the position of the light-emitting unit 20 at a predetermined position and that is provided in the fixture body 10.

As shown in FIGS. 6(A) and 6(B), the fixture body 10 includes a mounting member 11, a side plate 12 (12a and 12b), a spring portion 13 (13a and 13b), and a terminal block 14. A hole portion for a hanging bolt 15 and a hole portion for a power supply cable 16 are formed in the mounting member 11.

Hereinafter, each portion of the fixture body 10 will be described in detail.

The mounting member 11 includes a bottom plate portion 114 corresponding to the bottom of the light-emitting unit mounting recess 111, and side edges 112 formed with the light-emitting unit mounting recess 111 interposed therebetween and extending in the longitudinal direction of the bottom plate portion 114. The recess is formed by the bottom plate portion 114 and the side edges 112 on the cross-section of the mounting member 11 in its longitudinal direction.

The mounting member 11 is formed using, for example, a metal plate. That is, most of the light-emitting unit mounting recess 111 provided with an opening is formed by bending the metal plate. The light-transmissive cover 22 of the light-emitting unit 20 including the light-emitting element 21 and the light-transmissive cover 22 that covers the light-emitting element 21 is inserted into the opening. The mounting member 11 may be formed by injection molding or press molding, using, for example, resin materials other than the metal plate. The light-emitting unit mounting recess 111 widens toward the end edge of the opening of the light-emitting unit mounting recess 111.

The side edge 112 is constituted of, for example, a first side edge 112a and a second side edge 112b shown in FIG. 6(B). The side edge 112 has a protruding shape protruding in a direction perpendicular to the bottom plate portion 114 of the mounting member 11 and toward the light-emitting unit 20. At least one of the first side edge 112a and the second side edge 112b may have a protruding shape that protrudes toward the light-emitting unit 20 (that is, toward the −Z direction in FIGS. 6(A) and 6(B)).

The protruding shape herein is formed in an L-shape that stretches, for example, in an outside-extending form from each end of the bottom plate portion 114 in its short-side direction, and is then folded to the outer side of the bottom plate portion 114. A portion stretched from each end of the bottom plate portion 114 in its short-side direction is equivalent to the above-described inner wall constituting the light-emitting unit mounting recess 111, and a portion which is folded to constitute an L-shape is referred to as a folded portion. In addition, on the cross-section of the bottom plate portion 114 orthogonal to its longitudinal direction, the L-shaped folded portion is formed as the tip of the protruding shape.

The bottom plate portion 114 faces the mounting surface of a ceiling, a wall or the like, and includes the hole portion for a hanging bolt 15 to mount the lighting device 1 to the mounting surface, the hole portion for a power supply cable 16 to draw the power supply cable into the lighting device 1 and the like.

The side plate 12 is mounted to cover the ends (both ends) of the mounting member 11 in its longitudinal direction. As shown in FIG. 6(B), the first side plate 12a is mounted to cover one end of the mounting member 11. The second side plate 12b is mounted to cover the other end of the mounting member 11. The first and second side plates 12a and 12b are mounted to the mounting member 11, and thus the light-emitting unit mounting recess 111 and the opening are formed.

That is, light-emitting unit mounting recess 111 shows a space surrounded by the bottom plate portion 114, the first side edge 112a and the second side edge 112b, and the first side plate 12a and the second side plate 12b.

In addition, the “opening” shows a region surrounded by the folded portions (tip portions of the protruding shape) of the first side edge 112a and the second side edge 112b, and the end edge portions of the first side plate 12a and the second side plate 12b on the opposite side to the mounting surface.

As shown in FIGS. 7(A) and 7(B), the fixture body 10 may include a position regulation member 113 that regulates the mounting position of the light-emitting unit 20. The position regulation member 113 may be disposed in the light-emitting unit mounting recess 111.

The position regulation member 113 is brought into contact with the light-emitting unit 20 when the light-emitting unit 20 is mounted to the fixture body 10. Thereby, the light-emitting unit 20 is positioned at a predetermined position within the light-emitting unit mounting recess 111.

For example, as shown in FIG. 7(A), the position regulation member 113 may be provided to protrude from the inner wall constituting the light-emitting unit mounting recess 111 into the light-emitting unit mounting recess 111. In this case, the position regulation member 113 is constituted of a metal material or the like fixed to the inner wall constituting the light-emitting unit mounting recess 111, and is formed by a separate member from the light-emitting unit mounting recess 111.

In addition, the position regulation member 113 may be formed by bending a metal plate of the mounting member 11 to be integrally formed with the side edge 112. Specifically, a notch is formed in a portion of the inner wall constituting the light-emitting unit mounting recess 111, and the metal plate is bent so that the notch protrudes into light-emitting unit mounting recess 111. Thereby, it is possible to form the position regulation member 113 which is, for example, a cross-sectional lateral U-shaped or cross-sectional U-shaped protruding portion.

In addition, the position regulation member 113 may be disposed as a separate member in the side plate 12 mounted to cover the end of the mounting member 11 in its longitudinal direction. Alternatively, for example, as shown in FIG. 7(B), the position regulation member 113 may be integrally formed with the side plate 12.

In this case, the position regulation member 113 is provided with the side plate 12 in a state where the member protrudes from the side plate 12. Specifically, in a facing region (region shown by a dotted line in FIG. 7(B)) facing the light-emitting unit 20 when the light-emitting unit 20 is mounted to the fixture body 10, the position regulation member 113 is formed by bending a portion of the side plate 12 toward the light-emitting unit mounting recess 111.

As shown in FIG. 6(B), the spring portion 13 is fixed to, for example, the bottom plate portion 114 of the mounting member 11. The spring portion 13 is engaged with a spring receiving portion 27 of the light-emitting unit 20 described later, and thus is used to maintain a state where the light-emitting unit 20 is inserted into the light-emitting unit mounting recess 111 of the fixture body 10.

Specifically, the first spring portion 13a is engaged with a first spring receiving portion 27a of the light-emitting unit 20, and the second spring portion 13b is engaged with a second spring receiving portion 27b of the light-emitting unit 20. That is, the first spring receiving portion 27a and the second spring receiving portion 27b, and the first spring portion 13a and the second spring portion 13b function as mounting state maintenance portions that maintain a state where the light-emitting unit 20 is mounted to the fixture body 10 (mounting member 11).

A power supply cable 40 described later connects to the terminal block 14. Specifically, the power supply cable 40 derived from the mounting surface a ceiling, a wall or the like electrically connects to a power supply portion 28 described later through the terminal block 14. The terminal block 14 is mounted to the mounting member 11 by, for example, a screw or the like.

The hole portion for a hanging bolt 15 is a hole portion provided to insert the hanging bolts 30 to mount the fixture body 10 to the mounting surface of a ceiling, a wall or the like using hanging bolts 30 shown in FIG. 4(A) and FIG. 4(B).

The hole portion for a power supply cable 16 is a hole portion provided to draw the power supply cable 40 derived from the mounting surface of a ceiling, a wall or the like into the light-emitting unit mounting recess 111 of the fixture body 10.

### Light-Emitting Unit

Hereinafter, the configuration of the light-emitting unit 20 will be described.

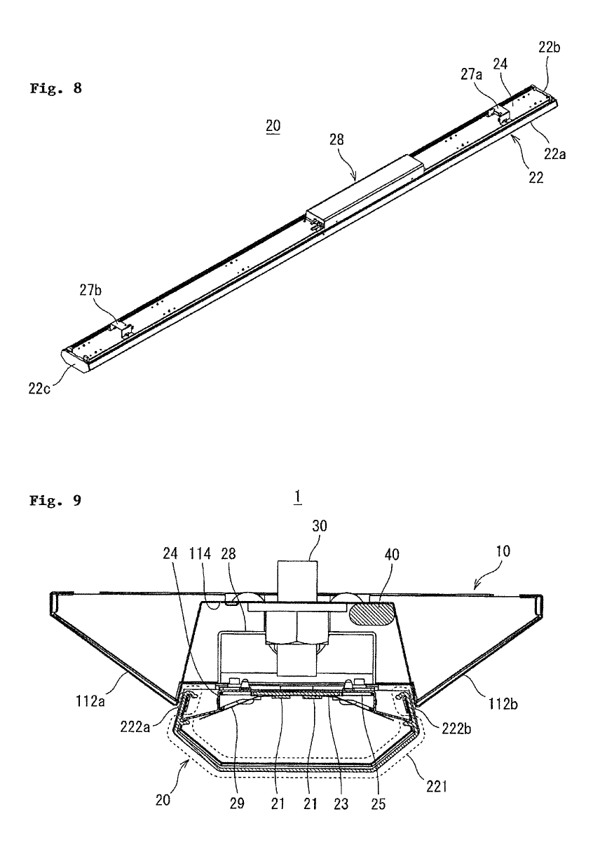

FIG. 8 is a perspective view illustrating the appearance of the light-emitting unit 20 from its upward direction.

FIG. 9 is a cross-sectional view of the lighting device 1 including the light-emitting unit 20.

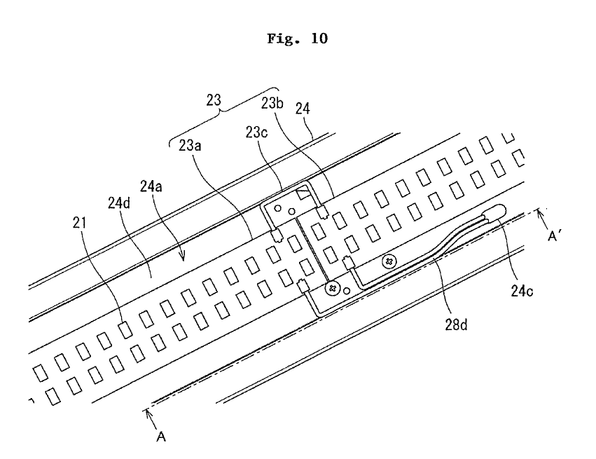

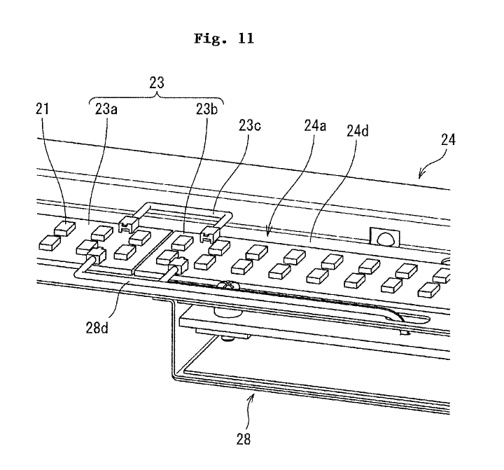

FIG. 10 is a plan view illustrating a light-emitting element substrate 23 included in the light-emitting unit 20.

FIG. 11 is a perspective cross-sectional view an A-A′ cross-section shown in FIG. 10.

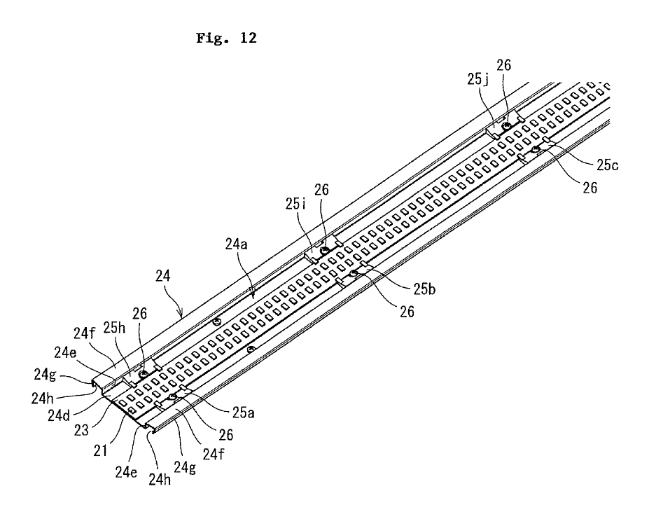

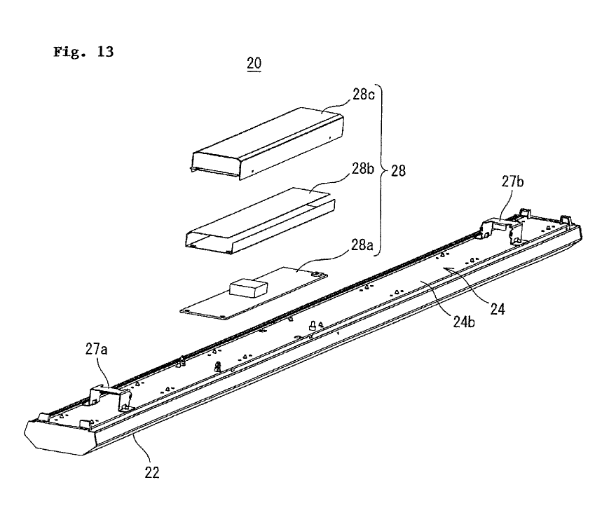

FIG. 12 is an enlarged perspective view of a portion of a light-emitting element support member 24 shown in FIGS. 4(A) and 4(B) on a substrate support region 24a side.

FIG. 13 is an exploded perspective view illustrating the configuration of the power supply portion 28 of the light-emitting unit 20. Meanwhile, other portions of the light-emitting unit 20 are also shown for the purpose of facilitating understanding.

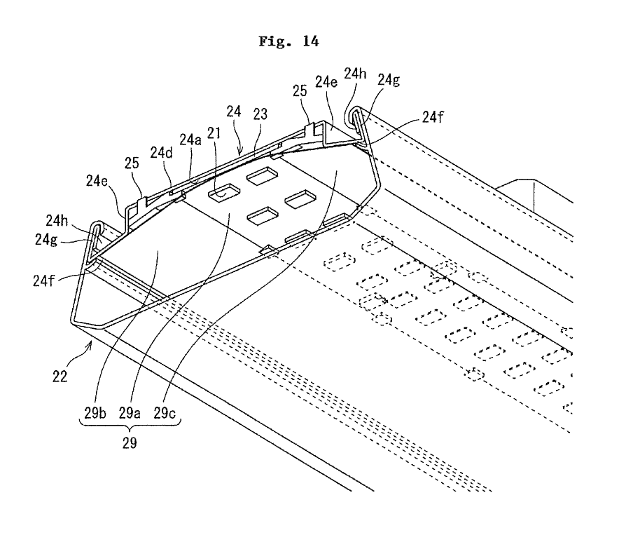

FIG. 14 is a cross-sectional perspective view illustrating the configuration of a reflecting member 29 of the light-emitting unit 20.

As shown in FIG. 8 and FIGS. 4(A) and 4(B), the light-emitting unit 20 includes the light-emitting element 21 and the light-transmissive cover 22 (22a, 22b and 22c). The light-emitting unit 20 may include, for example, the light-emitting element substrate 23, the light-emitting element support member 24, substrate fixing members 25 (25a to 25n), screws 26, the spring receiving portions 27 (27a and 27b), the power supply portion 28, and the reflecting member 29, in addition to the light-emitting element 21 and the light-transmissive cover 22.

In FIGS. 4(A) and 4(B), only a screw 26 that fixes the substrate fixing member 25a is denoted by a reference numeral, and screws that fix the substrate fixing members 25b to 25n are not denoted by reference numerals.

Hereinafter, each portion of the light-emitting unit 20 will be described in detail.

The light-transmissive cover 22 covers the light-emitting element 21, and has a shape in which the light-transmissive cover 22 is inserted into the fixture body 10 when the light emitting unit 20 is mounted to the fixture body 10. The light-transmissive cover 22 is formed in an elongated shape and the cross-section of the light-transmissive cover 22 orthogonal to its longitudinal direction is U-shaped as shown in FIG. 9, except for its end in the longitudinal direction. In addition, the light-transmissive cover 22 has a function of diffusing light radiated from the light-emitting element 21.

As shown in FIGS. 4(A) and 4(B), the light-transmissive cover 22 includes a main cover 22a that covers the light-emitting element 21, a first end cover 22b, and a second end cover 22c. The first end cover 22b is mounted to cover one end of the main cover 22a. Similarly, the second end cover 22c is also mounted to cover the other end of the main cover 22a.

In addition, as shown in FIG. 9, the main cover 22a of the light-transmissive cover 22 includes a light transmission portion 221 that transmits light radiated from the light-emitting element 21, and an insertion portion 222 inserted into the fixture body. Meanwhile, the insertion portion 222 includes a first insertion portion 222a and a second insertion portion 222b.

That is, the main cover 22a includes the insertion portion 222 on a side close to the bottom plate portion 114 of the mounting member 11, in the cross-section of the main cover 22a orthogonal to its longitudinal direction. The amount of insertion of the insertion portion 222 is larger than the amount of warpage of the light-emitting unit 20 when the light-emitting unit 20 is mounted to the fixture body 10.

The insertion portion 222 which is a portion of the light-transmissive cover 22 is inserted into the light-emitting unit mounting recess 111 of the fixture body 10, and thus the appearance defect of the lighting device is not likely to occur even when the light-emitting unit 20 warps. This is because the insertion portion 222 of the light-transmissive cover 22 inserted into the light-emitting unit mounting recess 111 is just exposed when the light-emitting unit 20 warps, and a gap does not occur between the fixture body 10 and the light-emitting unit 20.

The main cover 22a has a shape in which the opening-side end constituting a U-shape which is a shape of the cross-section of the main cover 22a is bent to the inner side and lower side. The “lower side” refers to the end side of the main cover 22a located on the opposite side to the U-shaped opening-side end. The main cover 22a is formed in an inside-narrowing form inclined from the lower side toward the opening-side end to the inner side, except for a bent portion of the opening-side end, in the cross-section of the main cover 22a.

In addition, the main cover 22a includes a protruding piece protruding inside at a region away from the opening-side end, in the cross-section of the main cover 22a orthogonal to its longitudinal direction. As shown in FIG. 14, a distance between the end and the protruding piece corresponds to the length of a folded portion of the light-emitting element support member 24 described later. Thereby, a region (fitting portion) between the bent portion of the end of the main cover 22a and the protruding piece is fitted to the folded portion of the light-emitting element support member 24, and the light-transmissive cover 22 is mounted to the light-emitting element support member 24. In a state where the light-transmissive cover 22 is mounted to the light-emitting element support member 24, the folded portion of the light-emitting element support member 24 and the inner surface of the light-transmissive cover 22 are in contact with each other.

The insertion portion 222 of the light-transmissive cover 22 is disposed in a region where the region (fitting portion) between the bent portion of the end of the main cover 22a and the protruding piece is present. Thereby, heat generated during the light emission of the light-emitting element 21 is conducted to the mounting member 11 through the light-emitting element substrate 23, the light-emitting element support member 24 and the light-transmissive cover 22.

The light-emitting unit 20 is mounted to the fixture body 10 in a state where the inside narrowing insertion portion 222 is in contact with the outside extending inner wall of the light-emitting unit mounting recess 111 of the fixture body 10. In this case, only a portion of the insertion portion 222 may be in contact with the light-emitting unit mounting recess 111, but the entire surface of the insertion portion 222 may be in contact with the light-emitting unit mounting recess 111.

As shown in FIGS. 4(A) and 4(B), the light-emitting element substrate 23 is a plate-like member extending long in one direction, and has a plurality of light-emitting elements 21 mounted on one surface. In addition, as shown in FIG. 10, the light-emitting element substrate 23 may be configured such that a plurality of substrates are connected to each other (for example, a substrate 23a and a substrate 23b are connected to each other).

As shown in FIGS. 10 and 11, wiring that supplies power to the light-emitting element 21 connects to the light-emitting element substrate 23. Wiring 28d connects light-emitting element substrate 23 to the power supply portion 28 through a through-hole 24c provided in a substrate support region 24a of the light-emitting element support member 24 described later. Power converted from alternating-current power into direct-current power by a power supply circuit of the power supply portion 28 is supplied to the light-emitting element 21 through the wiring 28d. Wiring 23c shown in FIGS. 10 and 11 is a wiring that electrically connects the substrate 23a to substrate 23b when the light-emitting element substrate 23 is constituted of a plurality of (two) substrates (substrate 23a and substrate 23b).

The light-emitting element support member 24 supports the light-emitting element substrate 23 having the light-emitting element 21 mounted thereto. Meanwhile, the light-emitting element support member 24 may indirectly mount the light-emitting element 21 with the light-emitting element substrate 23 interposed therebetween, and may directly mount the light-emitting element 21. The light-emitting element support member 24 has also a function of a heat sink that radiates heat of the light-emitting element 21.

As shown in FIGS. 4(A) and 4(B), the light-emitting element support member 24 includes a lower surface provided with the substrate support region 24a that supports the light-emitting element substrate 23, and an upper surface 24b for fixing the power supply portion 28. The substrate support region 24a is formed to be larger than the width of the light-emitting element substrate 23.

In addition, the light-emitting element support member 24 is formed so that the substrate support region 24a that supports the light-emitting element substrate 23 is dented in the direction of the fixture body 10. That is, for example, as shown in FIGS. 4, 12 and 14, the light-emitting element support member 24 includes a flat plate portion 24d in which the substrate support region 24a is present, an upright standing portion 24e that stands upright from the end edge of the flat plate portion 24d in its width direction to the light-transmissive cover 22 side, an inclined portion 24f inclined in an outside-extending form from the upright standing tip of the upright standing portion 24e to the outer side in the width direction with increasing distance from the flat plate portion 24d, a folded portion 24g folded from the inclined tip of the inclined portion 24f toward the end of the flat plate portion 24d in its width direction, and a contact portion 24h folded from the folded tip of the folded portion to the inner side and contacts the folded portion. That is, the flat plate portion 24d includes the substrate support region 24a which is a lower surface and the upper surface 24b. The light-emitting element support member 24 fixes the light-emitting element substrate 23 through the substrate fixing members 25 provided on both ends of the light-emitting element substrate 23 in its width direction, in the substrate support region 24a.

In addition, as shown in FIGS. 10 and 11, the light-emitting element support member 24 includes the through-hole 24c to pass the wiring 28d connected to the substrate support region 24a. The through-hole 24c is provided on the outer side of a region in which the light-emitting element substrate 23 is disposed and a position or its vicinity where the power supply portion 28 is fixed on the rear surface within the substrate support region 24a. The through-hole 24c is provided at a position (position at which the power supply portion 28 is fixed) facing the power supply portion 28, and thus the wiring 28d derived from the power supply portion 28 can be connected to the light-emitting element substrate 23 without being routed into a wide region on the light-emitting element support member 24. Therefore, the wiring 28d can be shortened, and thus the assemblability of the light-emitting unit 20 is improved.

In addition, the light-emitting element substrate 23 is covered with the light-transmissive cover 22, and the wiring 28d passes through the through-hole 24c. For this reason, the wiring 28d is not exposed to the outside, its safety is improved, and double coating of the wiring is not required.

A plurality of substrate fixing members 25 are provided in the longitudinal direction on both ends of the elongated light-emitting element substrate 23 in its short-side direction, in the substrate support region 24a of the light-emitting element support member 24. As shown in FIGS. 4(A) and 4(B) and FIG. 12, in this example, a plurality of substrate fixing members 25a to 25n are included on both ends of the light-emitting element substrate 23. Hereinafter, the substrate fixing member 25a to the substrate fixing member 25n are referred to as the substrate fixing member 25.

As shown in FIG. 12, the substrate fixing member 25 includes a locking claw that protrudes from the outer side of the light-emitting element substrate 23 onto the light-emitting element mounting surface of the light-emitting element substrate 23 toward the short-side direction of the light-emitting element substrate 23. The end surface (lateral side) of the substrate fixing member 25 facing the light-emitting element substrate 23 is provided to be in contact with or in proximity to the side portion of the light-emitting element substrate 23. The substrate fixing member 25 is fixed to the light-emitting element support member 24 by, for example, the screw 26.

For this reason, the light-emitting element substrate 23 is fixed to the light-emitting element support member 24 not to float.

As shown in FIG. 13, the spring receiving portion 27 is engaged with the spring portion 13 (see FIG. 7(B)) of the fixture body 10, and thus is used to maintain a state where the light-emitting unit 20 is mounted to the fixture body 10 so that a portion of the light-emitting unit 20 is inserted into the light-emitting unit mounting recess 111. Specifically, the first spring receiving portion 27a is engaged with the first spring portion 13a of the fixture body 10, and the second spring receiving portion 27b is engaged with the second spring portion 13b of the fixture body 10.

That is, the spring portion 13 (first spring portion 13a and second spring portion 13b) and the spring receiving portion 27 (first spring receiving portion 27a and second spring receiving portion 27b) function as mounting state maintenance portions that maintain a state where the light-emitting unit 20 is mounted to the mounting member 11.

The mounting state maintenance portion has a structure of locking between the spring receiving portion 27 and the spring portion 13, as described above. The spring portion 13 serves as a locking portion, and the spring receiving portion 27 serves as a portion to be locked. In the structure shown in FIG. 13, the spring portion (locking portion) is provided in the fixture body 10, and the spring receiving portion (portion to be locked) is provided in the light-emitting unit 20, but the spring portion (locking portion) may be provided in the light-emitting unit, and the spring receiving portion (portion to be locked) may be provided in the fixture body.

When the light-emitting unit 20 is mounted to the fixture body 10, the spring portion 13 has a spring function of generating a load in a direction in which the insertion portion 222 of the light-transmissive cover 22 presses the inner wall constituting the light-emitting unit mounting recess 111 of the fixture body 10. Thereby, the fixture body 10 and the light-emitting unit 20 are reliably brought into contact with each other, and heat generated during the light emission of the light-emitting element 21 can be conducted to the fixture body 10 side.

As long as a state where the light-emitting unit 20 is mounted to the fixture body 10 is maintained, the mounting state maintenance portion may have a shape different from those of the spring portion 13 and the spring receiving portion 27 described in the example.

The power supply portion 28 houses a lighting circuit (that is, power supply circuit) of the light-emitting element 21 such as an LED therein. The power supply portion 28 connects to the power supply cable 40 derived from the mounting surface to which the fixture body 10 shown in FIG. 9 is mounted into the light-emitting unit mounting recess 111.

As shown in FIG. 13, the power supply portion 28 includes a power supply substrate 28a provided with a power supply circuit, a heat sink 28b, a power supply box 28c that houses the power supply substrate 28a and the heat sink 28b therein, and the wiring 28d (wiring 28d is not shown in FIG. 13) that supplies power to the light-emitting element 21.

The power supply circuit included in the power supply substrate 28a converts, for example, alternating-current power supplied from the power supply cable 40 into a direct current, and the output (that is, direct-current power) is supplied to the light-emitting element 21 through the wiring 28d. The power supply substrate 28a is fixed to the inner surface of the heat sink 28b having a shape described later, and the surface on the light-emitting element support member 24 side.

The heat sink 28b is made of a material such as aluminum or copper. As shown in FIG. 13, the heat sink 28b is formed in a polygonal cylindrical shape (in this example, shape close to a square cylinder) obtained by bending a plate-like material multiple times, but the shape of the heat sink 28b is not limited thereto. A shape having the large area in contact with the power supply substrate 28a is preferable from the viewpoint of heat dissipation.

The power supply box 28c is made of a material such as plastic, aluminum or stainless, and has a box shape extending in one direction. The wiring 28d connects to the light-emitting element substrate 23 through the through-hole 24c provided in the substrate support region 24a of the light-emitting element support member 24.

The power supply portion 28 is fixed to the upper surface 24b of the light-emitting element support member 24 by, for example, a claw portion (not shown) provided in the power supply box 28c. In addition, the power supply portion 28 may be fixed to the upper surface 24b of the light-emitting element support member 24 by a fastening member such as a screw.

The power supply portion 28 overlaps the power supply cable 40 when viewed from the normal direction of the mounting surface. That is, as shown in FIG. 9, the power supply cable 40 is wired in a space secured between the upper surface of the power supply portion 28 and the fixture body 10. Therefore, the power supply cable 40 does not interfere with mounting the light-emitting unit 20.

The reflecting member 29 has a function of reflecting light radiated from the light-emitting element 21. The light radiated from the light-emitting element 21 is reflected in a direction (for example, direction toward a floor face) set in advance by the reflecting member 29. The reflecting member 29 is fixed by an adhesive, a pin, a screw or the like at any places of the light-emitting element substrate 23, the light-emitting element support member 24, the substrate fixing member 25 or the like.

The reflecting member 29 is provided on the light-emitting element mounting surface side of the light-emitting element substrate 23 within the light-transmissive cover 22. The reflecting member 29 is obliquely disposed to be distant from the light-emitting element substrate 23. Specifically, for example, as shown in FIG. 14, the reflecting member 29 includes a first reflecting portion 29a that exposes the light-emitting element 21 and covers the light-emitting element substrate 23.

In addition, a resistive element not shown may be provided on the light-emitting element mounting surface side of the light-emitting element substrate 23. In this case, the first reflecting portion 29a is provided with an opening to expose the light-emitting element 21, and an opening to expose the resistive element.

In addition, the reflecting member 29 includes a second reflecting portion 29b obliquely disposed to be distant from the mounting surface with increasing distance in a width direction from one end of the first reflecting portion 29a in its width direction, and a third reflecting portion 29c obliquely disposed to be distant from the mounting surface with increasing distance in a width direction from the other end of the first reflecting portion 29a in its width direction.

The reflecting member 29 is sheet-shaped, has an opening in a portion facing the light-emitting element 21, and is disposed across a pair of inclined portions of the light-emitting element support member 24 and the light-emitting element substrate 23.

The opening to expose, for example, the light-emitting element 21 is formed in the first reflecting portion 29a. Thereby, light radiated from the light-emitting element 21 is reflected from the entire surfaces of the first reflecting portion 29a, the second reflecting portion 29b and the third reflecting portion 29c, and is efficiently used in the light emission of the lighting device 1.

According to the lighting device according to the example described above, the following effects can be obtained.

(1) Even when the light-emitting unit warps, a portion of the light-transmissive cover of the light-emitting unit inserted into the light-emitting unit mounting recess is just exposed, and thus the appearance defects of the lighting device do not occur.
(2) Since the space of the light-emitting unit mounting recess can be extended, the workability of mounting the light-emitting unit is improved, and the capacity for the power supply portion, the cable for power supply or the like of the light-emitting unit is improved.
(3) The excellent appearance of the lighting device can be maintained, and the light-emitting unit is in contact with a region of at least a portion of the inner wall constituting the light-emitting unit mounting recess, thereby allowing the mounting position of the light-emitting unit to be positioned.
(4) A space in which the power supply cable housed is secured between the bottom of the light-emitting unit mounting recess and the light-emitting unit, and thus the power supply cable 40 does not interfere with mounting the light-emitting unit 20.
(5) The light-emitting unit is attracted to the fixture body by the mounting state maintenance portion, and thus it is possible to prevent the light-emitting unit from deviating from the fixture body.
(6) Since the wiring within the light-emitting unit can be shortened, the assemblability of the light-emitting unit is improved. In addition, since the wiring is not exposed to the outside, its safety is improved, and double coating of the wiring is not required.

The scope of this disclosure is not limited to the examples illustrated and described in the drawings, and may involve all examples which will bring about equivalent effects. Further, the scope of the disclosure is not limited to a combination of features defined in the appended claims, and can be defined by any desired combinations of specific features out of all the respective features disclosed herein.

1-39. (canceled)

40. A lighting device comprising:
an elongated light-emitting unit including a light-emitting element and a light-transmissive cover that covers the light-emitting element; and
a fixture body to which the light-emitting unit is mounted,
wherein a cross-section of the light-transmissive cover orthogonal to a longitudinal direction of the light-emitting unit is U-shaped, and
the fixture body includes a light-emitting unit mounting recess into which at least an opening-side end constituting the U-shape of the light-transmissive cover is inserted.

41. The lighting device according to claim 40, wherein the light-emitting unit mounting recess widens from a bottom of the light-emitting unit mounting recess toward an opening end edge.

42. The lighting device according to claim 40, wherein a portion of the light-transmissive cover inserted into the light-emitting unit mounting recess is in contact with an inner wall constituting the light-emitting unit mounting recess.

43. The lighting device according to claim 42, wherein the light-transmissive cover includes:
a light transmission portion that transmits light radiated from the light-emitting element; and
an insertion portion inserted into the light-emitting unit mounting recess,
wherein the light-emitting unit is mounted to the fixture body in a state where the insertion portion of the light-transmissive cover is in contact with the inner wall of the light-emitting unit mounting recess.

44. The lighting device according to claim 40, wherein the light-emitting unit includes a power supply portion connected to a power supply cable derived from a mounting surface to which the fixture body is mounted into the light-emitting unit mounting recess, and
the power supply portion overlaps the power supply cable when viewed from a direction normal to the mounting surface.

45. The lighting device according to claim 43, further comprising a mounting state maintenance portion that maintains a state where the light-emitting unit is mounted to the fixture body in a state where the insertion portion is inserted into the light-emitting unit mounting recess.

46. The lighting device according to claim 45, wherein the mounting state maintenance portion includes a locking structure, and
the locking structure includes a spring portion that generates a load in a direction in which the insertion portion of the light-transmissive cover presses the inner wall.

47. The lighting device according to claim 40, wherein the light-emitting unit includes a light-emitting element support member that supports the light-emitting element,
a light-emitting element substrate to which the light-emitting element is mounted, and
the light-emitting element support member and the light-transmissive cover are in contact with each other.

48. The lighting device according to claim 47, wherein the light-emitting element support member includes a flat plate portion to mount the light-emitting element, an upright standing portion standing upright from an end edge of the flat plate portion in its width direction to the light-transmissive cover side, an inclined portion extending outwardly from an upright standing tip of the upright standing portion and is inclined in an outside-extending form to an outer side of the flat plate portion in its width direction with increasing distance from the flat plate portion, and a folded portion folded from an inclined tip of the inclined portion toward an end of the flat plate portion in its width direction.

49. The lighting device according to claim 48, wherein the light-emitting element support member includes a space surrounded by the upright standing portion, the inclined portion, and the folded portion.

50. The lighting device according to claim 48, wherein the light-transmissive cover includes a fitting portion fitted to the folded portion of the light-emitting element support member.

51. The lighting device according to claim 50, wherein the insertion portion is disposed in a region where the fitting portion is present.

52. A fixture body for a lighting device, wherein a light-emitting unit is mounted in which a light-emitting element is covered with a light-transmissive cover having an elongated shape and of which a cross-section orthogonal to a longitudinal direction is U-shaped, and
the fixture body comprises a light-emitting unit mounting recess into which at least an opening-side end constituting the U-shape in the light-transmissive cover is inserted.

53. A light-emitting unit comprising:
a light-emitting element; and
a light-transmissive cover that covers the light-emitting element,
wherein the light-transmissive cover is configured such that a cross-section of the light-transmissive cover orthogonal to a longitudinal direction of the light-transmissive cover is U-shaped, and that when the light-emitting unit is mounted to a fixture body for a lighting device including a light-emitting unit mounting recess for light-emitting unit mounting, at least an opening-side end constituting the U-shape is inserted into the light-emitting unit mounting recess and has an elongated shape.

54. The lighting device according to claim 41, wherein the fixture body further comprises:
a bottom plate portion corresponding to the bottom of the light-emitting unit mounting recess; and
side edges formed with the light-emitting unit mounting recess interposed therebetween and extending in a longitudinal direction of the bottom plate portion,
wherein the side edge has a protruding shape that protrudes toward a direction perpendicular to the bottom plate portion.

55. The lighting device according to claim 40, further comprising a position regulation member that regulates a mounting position of the light-emitting unit.

56. The lighting device according to claim 55, wherein the position regulation member is disposed within the light-emitting unit mounting recess.

57. The lighting device according to claim 47, wherein the light-emitting element substrate has an elongated shape, and is fixed to the light-emitting element support member by a substrate fixing member provided on both ends of the light-emitting element substrate in its short-side direction along a longitudinal direction of the light-emitting element substrate.

58. The lighting device according to claim 47, further comprising a reflecting member that reflects light radiated from the light-emitting element.

59. The lighting device according to claim 58, wherein the reflecting member is obliquely disposed to be orthogonal to the light-emitting element substrate with increasing distance toward an outer side of the light-emitting element substrate in its short-side direction and to be distant from a bottom of the light-emitting unit mounting recess.
